(19) United States
(12) Patent Application Publication
(10) Pub. No.: US 2013/0298015 A1
(43) Pub. Date: Nov. 7, 2013

(54) DOCUMENT IMAGE DISPLAY DEVICE, AND METHOD FOR CONTROLLING OPERATION OF SAME

(71) Applicant: Fujifilm Corporation, Tokyo (JP)

(72) Inventor: Erina OGURA, Tokyo (JP)

(21) Appl. No.: 13/893,186

(22) Filed: May 13, 2013

Related U.S. Application Data
(63) Continuation-in-part of application No. PCT/JP2011/076744, filed on Nov. 15, 2011.

(30) Foreign Application Priority Data
Nov. 18, 2010 (JP) 2010-257494

(51) Int. Cl. G06F 17/21

(52) U.S. Cl. CPC G06F 17/212
USPC 715/253

(57) ABSTRACT

A document image is viewed by scrolling along only one axis. To achieve this, a document is imaged to obtain a document image. A document image having a width identical with that of a display area is generated. When such a document image is generated, character images are extracted. These character images represent characters, which are contained in the document image, in the form of images. The extracted character images are re-arrayed in accordance with the flow of characters to thereby generate a document image. Since this document image has a width the same as that of the display area, it can be viewed merely by scrolling up and down.

### TECHNICAL FIELD

This invention relates to a document image display device and to a method for controlling the operation of this device.

### BACKGROUND ART

There are document images obtained by imaging a document rather than by representing the document by a text file (Japanese Patent Application Laid-Open Nos. 2001-266068, 2000-322511, 11-122398, 7-168911). Since such a document image is difficult to edit in comparison with a document represented by a text file, it is effective in cases where one does not wish to change the content of the document. In a case where a document image is viewed on a mobile telephone such as one referred to as a so-called “smart phone”, the fact that the display screen is small in size makes it necessary to scroll the document a number of times up and down as well as left and right.

### DISCLOSURE OF THE INVENTION

An object of the present invention is to enable a document image to be viewed merely by scrolling along one axis.

A document image display device according to the present invention is characterized by comprising: display area positioning means (a display area positioning device) for positioning a display area, which defines a zone in which a display is presented on a display screen of a display unit, on a document image obtained by imaging a document; character image array means (a character image array device) which, on the basis of positional coordinates of each character contained in the document image, is for arraying character images, which are the result of character-by-character extraction of character images representing the characters contained in the document image, within the display area in order in accordance with flow of the characters from a character being displayed uppermost in the display area in a case where flow of the document is that of horizontal writing, and within the display area in order in accordance with flow of the characters from a character being displayed rightmost in the display area in a case where flow of the document is that of vertical writing; and a display unit for displaying the character images, which have been arrayed within the display area by the character image array means, on the display screen.

The present invention provides also an operation control method suited to the document image display device described above. Specifically, the method comprises: display area positioning means positioning a display area, which defines a zone in which a display is presented on a display screen of a display unit, on a document image obtained by imaging a document; on the basis of positional coordinates of each character contained in the document image, character image array means arraying character images, which are the result of character-by-character extraction of character images representing the characters contained in the document image, within the display area in order in accordance with flow of the characters from a character being displayed uppermost in the display area in a case where flow of the document is that of horizontal writing, and within the display area in order in accordance with flow of the characters from a character being displayed rightmost in the display area in a case where flow of the document is that of vertical writing; and a display unit displaying the character images, which have been arrayed within the display area by the character image array means, on the display screen.

The present invention also provides a non-transitory recording medium storing a program for implementing the method of controlling the operation of the above-described document image display device. Furthermore, it may be arranged so that a program is provided.

In accordance with the present invention, a display area is positioned on a document image obtained by imaging a document. Character images representing characters contained in the document image are extracted on a per-character basis. Based upon the positional coordinates of each character contained in the document image, the character images are arrayed within the display area in order in accordance with the flow of characters from a character being displayed uppermost in the display area in a case where the flow of the document is that of horizontal writing, and in a case where the flow of the document is that of vertical writing, the character images are arrayed within the display area in order in accordance with the flow of characters from a character being displayed rightmost in the display area. The character images arrayed in the display area are displayed on a display screen. In accordance with the present invention, the character images contained in the document image are extracted character by character. In case of horizontal writing, the character images are arrayed in accordance with the flow of the characters from a character, which is being displayed uppermost in the display area, in such a manner that scrolling left and right is unnecessary. In case of vertical writing, the character images are arrayed in accordance with the flow of the characters from a character, which is being displayed rightmost in the display area, in such a manner that scrolling up and down is unnecessary. In the case of a document that is composed of horizontal writing, the document image can be viewed merely by scrolling left and right. In the case of a document that is composed of vertical writing, the document image can be viewed merely by scrolling up and down.

The device may further comprise command means (a command device) for applying an enlargement command or a reduction command; and display area changing means (a display area changing device) for reducing the display area in size in accordance with an enlargement command from the command means and enlarging the display in size in accordance with a reduction command from the command means.

In a case where the document image contains, in addition to character image areas containing the character images, original image areas representing images which are represented by image files before the document is imaged, the device may further comprise original image area adjusting means (an original image area adjusting device) for executing centering processing so as to center the original image areas in the display area and for executing reduction processing such that the original image areas will be included in the display area or enlargement processing such that the original image areas will match the display area; the character images being arrayed in the character image areas by the character image array means.

The device may further comprise layout changing means (a layout changing device) for rearranging placement of the original image areas and character image areas in accordance with flow of the characters; the document image having a width identical with width of the display area in regard to the document of horizontal writing and having a height identical with height of the display area in regard to the document of vertical writing.

### BRIEF DESCRIPTION OF THE DRAWINGS

FIG. 1 is an overview of a document image communication system;

FIG. 2 is a block diagram illustrating the electrical configuration of a mobile telephone;

FIG. 3 is a block diagram illustrating the electrical configuration of a document image server;

FIG. 4 is an example of a document image;

FIG. 5 illustrates an example of part of a document image;

FIG. 6 is a list of positional coordinates;

FIG. 7 is a flowchart illustrating the processing procedure of a document image server;

FIG. 8 is a flowchart illustrating the processing procedure of a mobile telephone;

FIG. 9 is an example of a document image;

FIG. 10 illustrates the manner in which a document image is changed;

FIGS. 11 to 15 are examples of document images;

FIG. 16 illustrates an example of part of a document image;

FIG. 17 is a list of positional coordinates;

FIG. 18 illustrates the manner in which a document image is changed; and

FIG. 19 is an example of a document image.

### BEST MODE FOR CARRYING OUT THE INVENTION

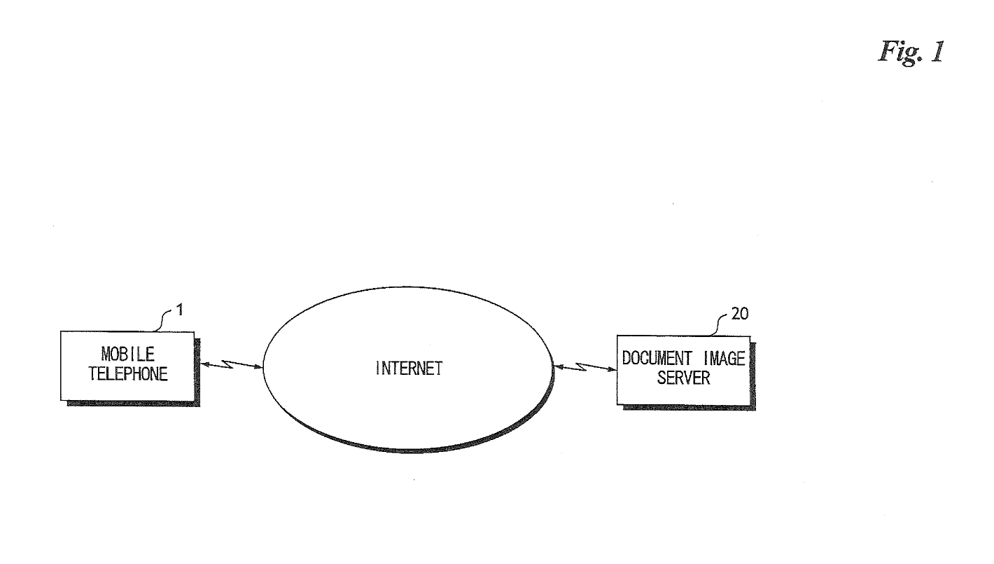

FIG. 1, which shows an embodiment of the present invention, illustrates an overview of a document image communication system (where a document that has been imaged is referred to as a “document image”).

The document image communication system according to this embodiment includes a mobile telephone 1 and a document image server 20 capable of communicating with each other via the Internet [the network is not limited to the Internet and may just as well be an in-house LAN (Local-Area Network) or the like]. A file representing a document image is transmitted from the document image server 20 to the mobile telephone 1 in response to a request from the mobile telephone 1.

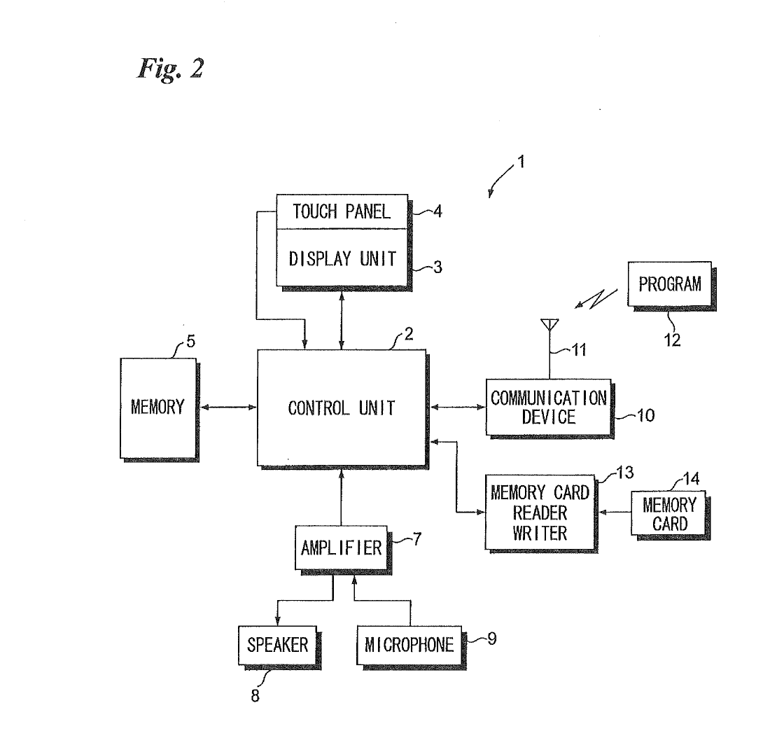

FIG. 2 is a block diagram illustrating the electrical configuration of the mobile telephone 1, referred to as a so-called “smart phone”.

The overall operation of the mobile telephone 1 is controlled by a control unit 2.

The mobile telephone 1 is provided with a communication device 10 and antenna 11 for communicating with other mobile telephones and for accessing the Internet. A program 12 for performing an operation described later is downloaded via the antenna 11. By installing the downloaded program 12 in the mobile telephone 1, the mobile telephone 1 will operate as described later. The mobile telephone 1 is provided with a memory card reader writer 13 as well. It may be arranged so that a program stored on a memory card 14 is read using the memory card reader writer 13 so that the program is installed in the mobile telephone 1.

The mobile telephone 1 is further provided with a display unit 3 for displaying documents and images and the like on a display screen. A touch panel 4 has been formed on the display screen of the display unit 3. By touching the touch panel 4 formed on the display screen, a user can apply various commands such as a scroll command and an enlargement or reduction command to the mobile telephone 1.

The mobile telephone 1 includes also a memory 5 in which a program and prescribed data are stored. The mobile telephone 1 further includes a speaker 8 and a microphone 9. A voice signal is amplified by an amplifier circuit 7 and applied to the speaker 8, whereby voice is output from the speaker 8. Further, a voice signal representing voice that has been input from the microphone 9 is amplified by the amplifier circuit 7 and input to a control unit 2.

In a case where a document image is viewed by being displayed on a small display screen, scrolling must be performed up, down and left, right. In this embodiment, it is arranged so that the document image can be viewed just by scrolling up and down or left and right.

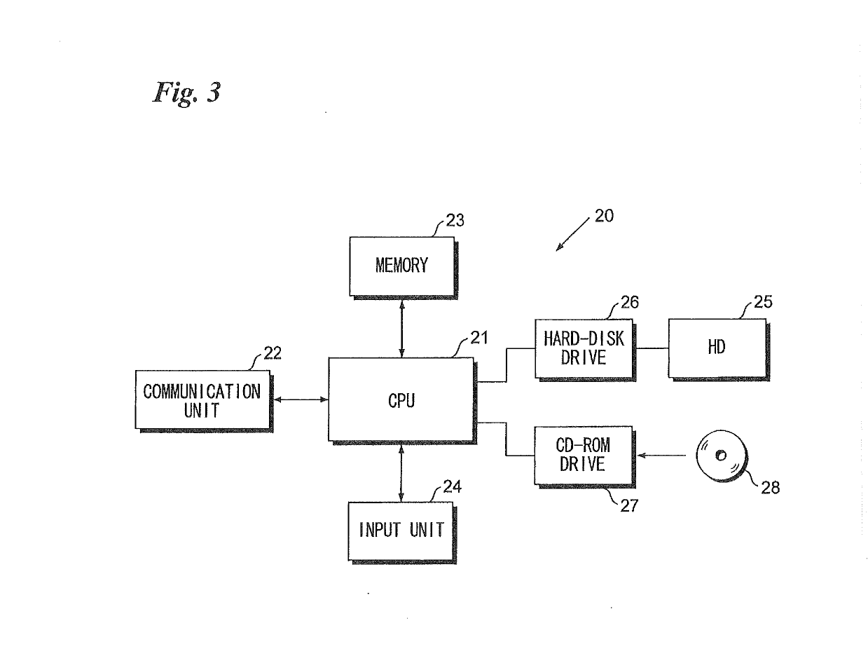

FIG. 3 is a block diagram illustrating the electrical configuration of the document image server 20.

The overall operation of the document image server 20 is controlled by a CPU 21.

The document image server 20 includes a communication unit 22 for accessing the Internet, a memory 23 for storing prescribed data and the like, an input unit 24 such as a keyboard, a hard disk 25, a hard-disk drive 26 for accessing the hard disk 25, and a CD-ROM (Compact-Disk Read-Only Memory) drive 27. A CD-ROM 28 storing a program for controlling an operation described later is loaded into the CD-ROM drive 27 and the program is read. The read program is installed in the document image server 20. The program may just as well be received via the Internet without being stored on a recording medium such as the CD-ROM 28.

A text file representing a document has been stored on the hard disk 25. The text file is read from the hard disk 25 and is converted by the CPU 21 to an image file representing a document image. The image file obtained by the conversion is stored on the hard disk 25.

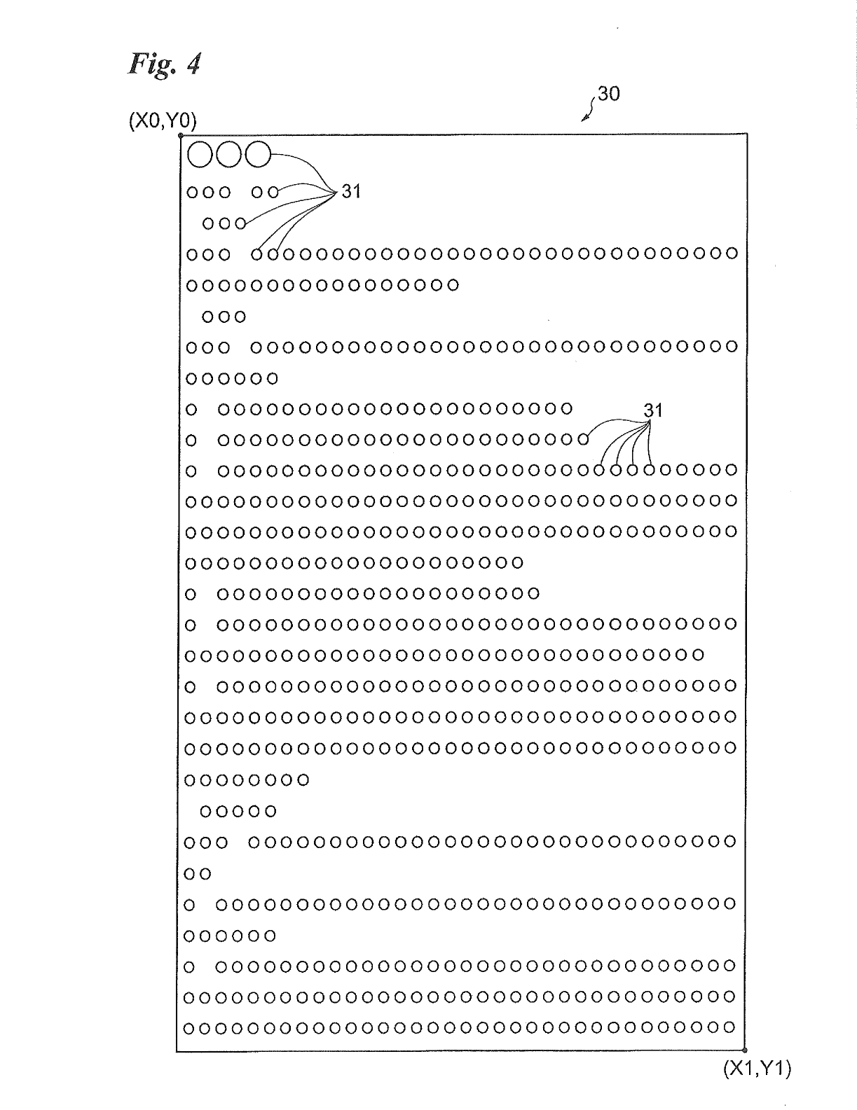

FIG. 4 is an example of a document image 30.

As mentioned above, the document image 30 is not one represented by a text file but one obtained by imaging a document represented by an image file. The document image 30 is an image represented by an image file. Character images representing characters in FIG. 4 are represented by circles 31.

The flow of the characters of the document image 30 is that of horizontal writing. Therefore the upper-left vertex is the origin and is represented by the positional coordinates (X0,Y0). The lower-right vertex is represented by the positional coordinates (X1,Y1).

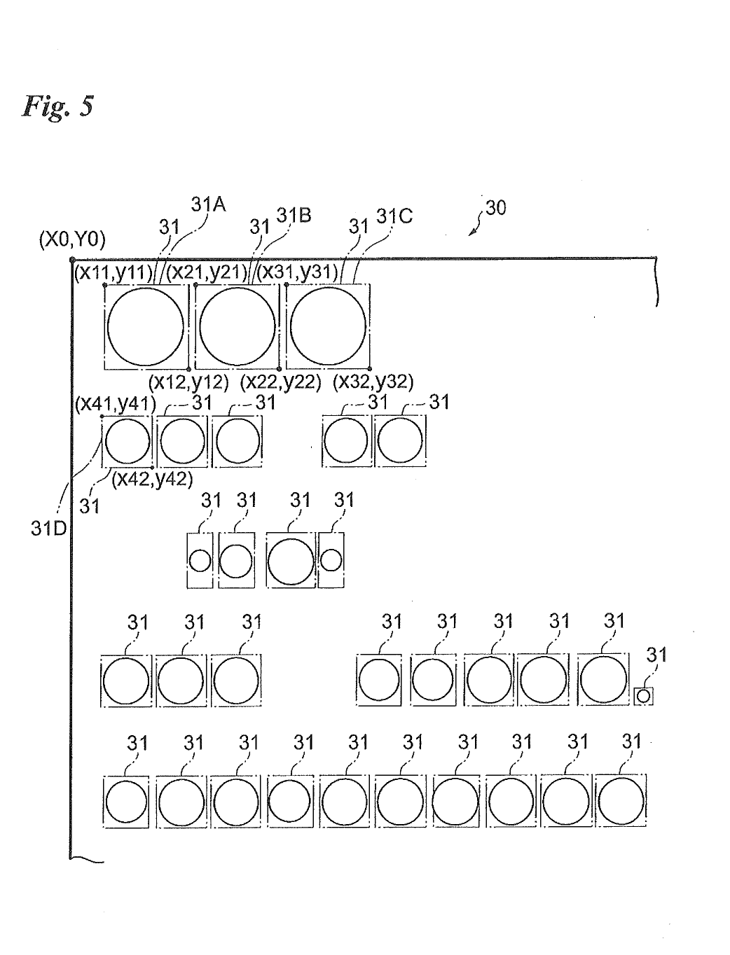

FIG. 5 illustrates part of the document image 30 enlarged in comparison with FIG. 4.

In this embodiment, the character images 31 representing the characters contained in the document image 30 are detected as rectangles (or as some other shape). The positional coordinates of the detected character images 31 are also detected and a list of positional coordinates is generated as set forth above.

Since the character flow of the document image is that of horizontal writing, the positional coordinates of each character image 31 are represented by the coordinates of the upper-left vertex and the coordinates of the lower-right vertex. The positional coordinates of a character image 31A representing the first character among the character images 31 are represented by (x11,y11) and (x12,y12). Similarly, the positional coordinates of a character image 31B representing the second character are represented by (x21,y21) and (x22,y22). The positional coordinates of a character image 31C representing the third character are represented by (x31,y31) and (x32,y32). The character image 31C representing the third character is followed by a line break. The coordinates of a character image 31D representing the fourth character are represented by (x41,y41) and (x42,y42). Positional coordinates are detected similarly with regard to the other character images 31.

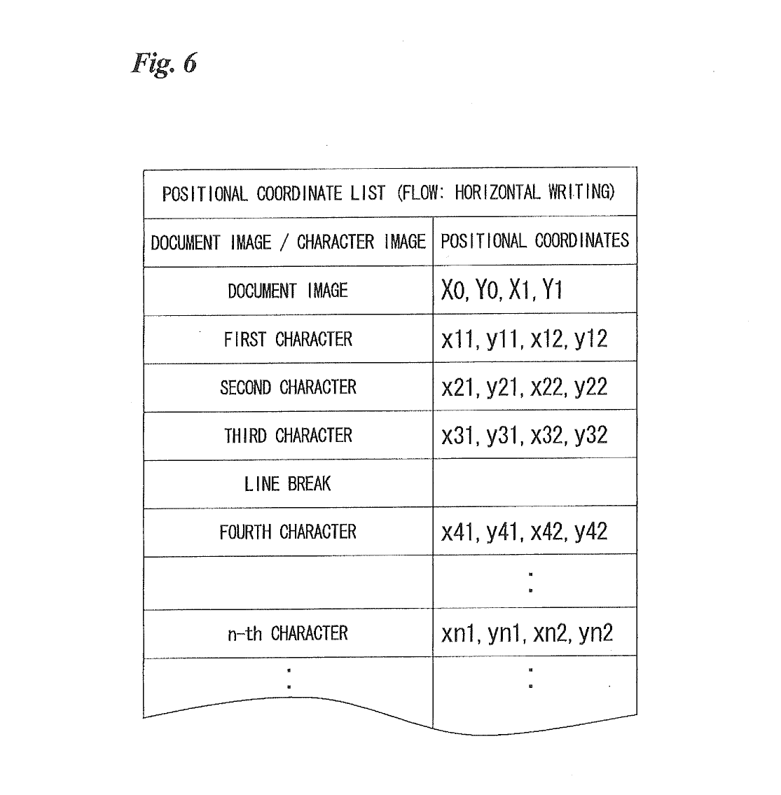

FIG. 6 is an example of a list of positional coordinates. This list of positional coordinates has been generated in association with the document image.

The list of positional coordinates also contains data indicating the character flow of the document image 30 (the flow is that of horizontal writing in the case of the document image 30 but it may just as well be that of vertical writing), as mentioned above.

The positional coordinates of the character images 31 have been stored in the list of positional coordinates in accordance with the character flow of the document image 30, as mentioned above. In a case where there is a line break, the positional coordinates that follow the positional coordinates of the character images 31 preceding the line break are left blank.

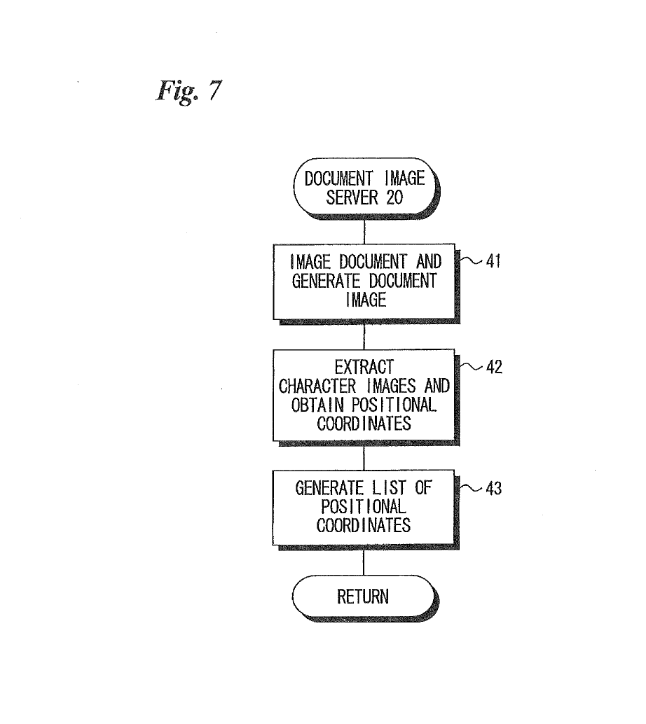

FIG. 7 is a flowchart illustrating the processing procedure of the document image server 20.

As mentioned above, the document image 30 is generated by imaging a document represented by a text file (step 41). Next, character images 31 are detected from the document image 30 and the positional coordinates thereof are obtained (step 42). A list of the positional coordinates is generated, as described above, from the positional coordinates obtained (step 43).

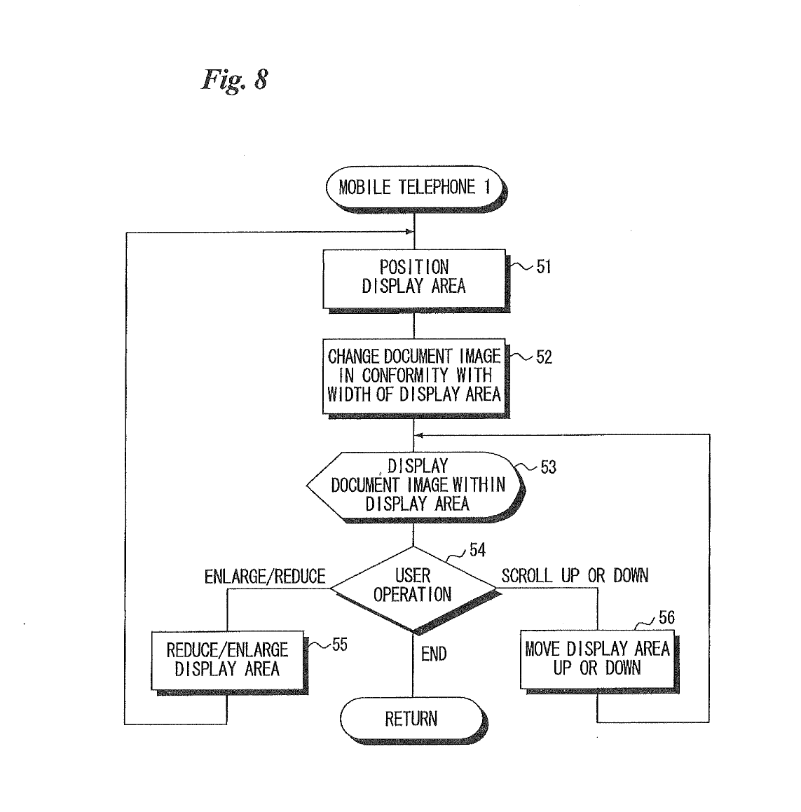

FIG. 8 is a flowchart illustrating the processing procedure of the mobile telephone 1.

It will be assumed that data requesting the document image 30 has been transmitted from the mobile telephone 1 to the document image server 20 and that, in response to this request data, the image file representing the document image 30 and the list of positional coordinates have been transmitted from the document image server 20 to the mobile telephone 1. The list of positional coordinates is planted in the header to the image file representing the document image 30. Naturally, data representing the list of positional coordinates may be transmitted from the document image server 20 by a file separate from that of the image file.

The image file opens in the memory 5 of the mobile telephone 1 and a display area is positioned on the document image 30 represented by the opened image file (step 51). The initial position of the display area would be at the upper left of the document image 30 if the document image 30 is one of horizontal writing. If the document image 30 is one of vertical writing, then the initial position of the display area would be at the upper right of the document image 30.

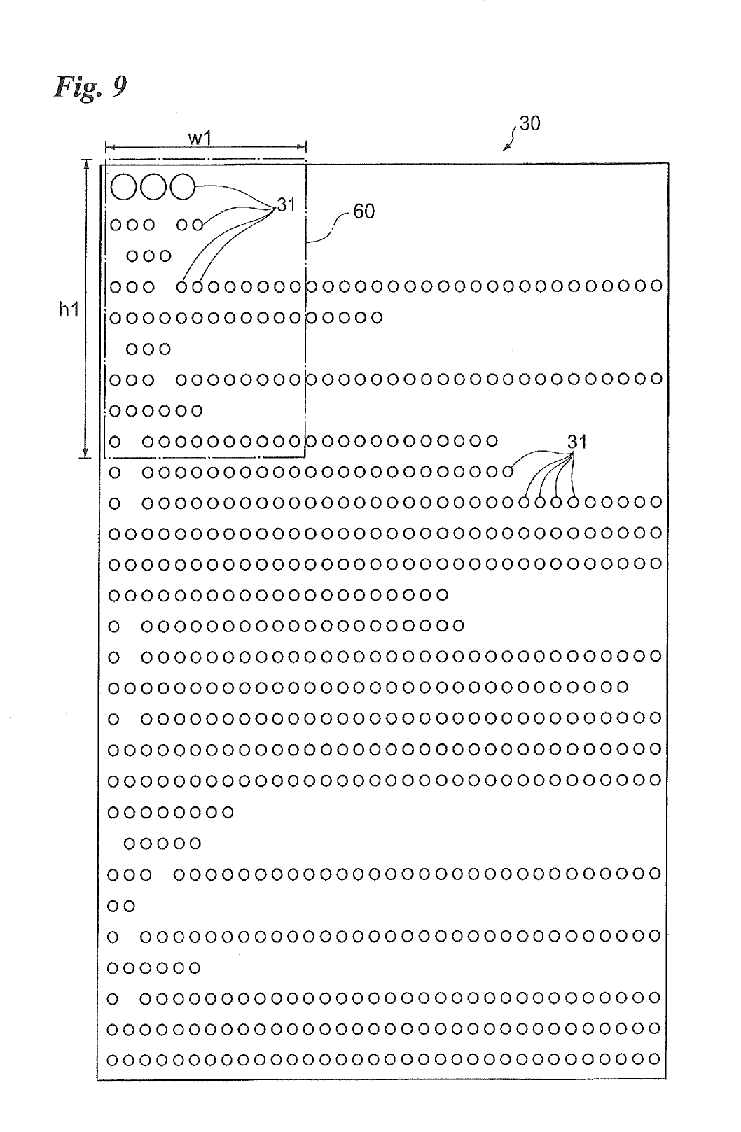

FIG. 9 is an example of the document image 30.

As mentioned above, a display area 60 is positioned in the document image 30. Let w1 represent the width of the display area 60, and let h1 represent the height thereof. The document image 30 within the display area 60 is displayed on the display screen of the display unit 3 of the mobile telephone 1. The display area 60 is moved by a scroll command applied to the touch panel 4 and is reduced or enlarged in size in accordance with an enlargement or reduction command.

Next, the document image 30 is changed in such a manner that the width thereof becomes the same as the width w1 of the display area 60 (step 52 in FIG. 8). The detected character images 31 are extracted from the document image 30 and, in accordance with the character flow of the document image 30, the extracted character images 31 are re-arrayed in the document image the width of which has been changed.

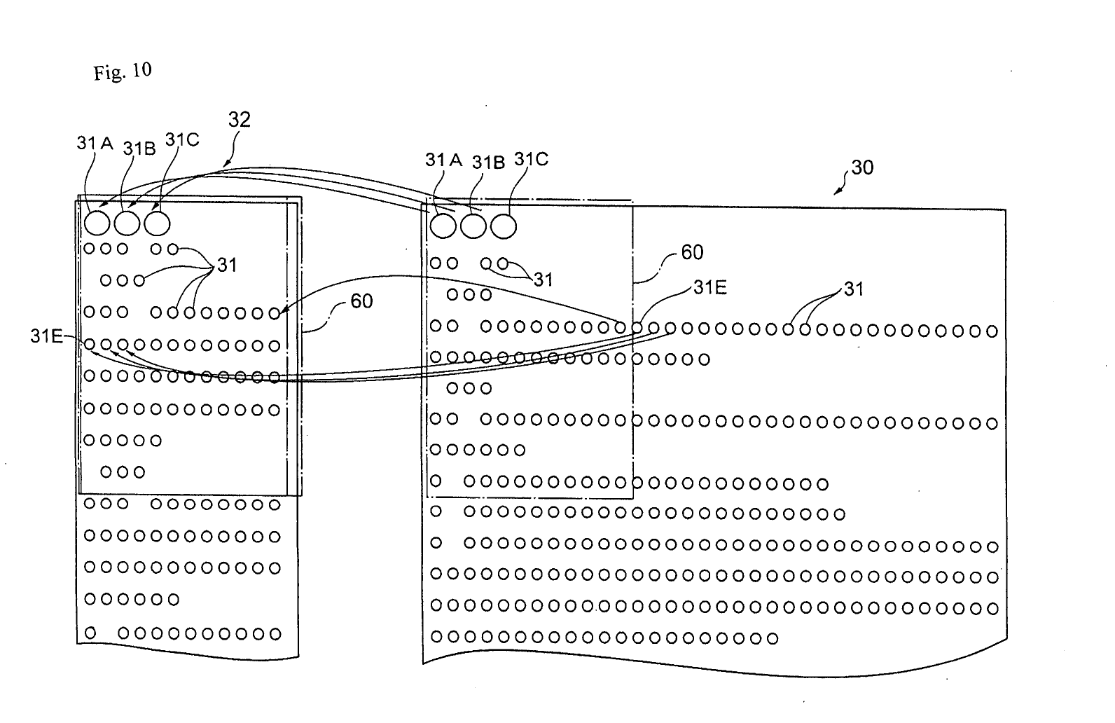

FIG. 10 illustrates the manner in which a document image 32, which has the width w1 identical with the width w1 of the display area 60, is generated.

In order to generate the document image 32 having the width w1 identical with the width w1 of the display area 60, the character images 31 constituting the document image 30 are extracted in accordance with the list of positional coordinates. The document image 32 is generated by arraying the extracted character images 31 in a sequence that is in accordance with the list of positional coordinates. For example, the document image 32 is generated by arraying the first character image 31A, second character image 31B and third character image 31C of the document image 30 in accordance with this character image sequence. Since the third character image 31C is followed by the line break, a line break is placed in the document image 32 as well. On the fourth line in the document image 30, there is a character image 31E that falls outside the display area 60. Thus a line break is provided in the document image 32 for the character image 31E that falls outside the display area 60. The difference between the x coordinate at the upper-left vertex of the character image 31 and the x coordinate of the lower-right vertex of the character image 31 is the width of the character image 31. By arraying, in accordance with character flow, a number of character images 31 for which the sum of the widths of a plurality of the character images 31 falls within the width w1 of the display area 60 and is closest to the width w1, the document image 32 having the width w1 is generated.

Thus, in a case where the flow of the characters is that of horizontal writing, the character images are arrayed within the display area 60 in order in accordance with the flow of the characters from the character being displayed uppermost in the display area 60. In a case where the flow of the characters is that of vertical writing, the character images are arrayed within the display area 60 in order in accordance with the flow of the characters from the character being displayed rightmost in the display area 60.

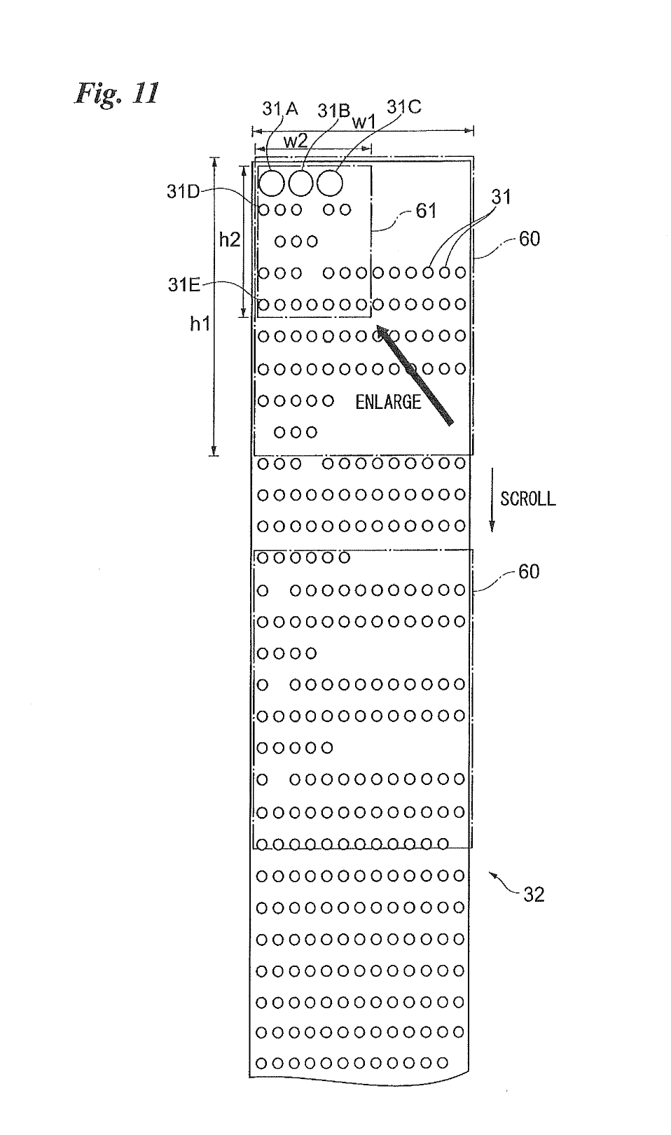

FIG. 11 is an example of the document image 32 thus generated.

The width of the document image 32 is w1, which is identical with the width w1 of the display area 60. Since the generated document image 32 is such that its character images 31 have been re-arrayed in accordance with character flow, the content of the document image 32 can be read in its entirety merely by scrolling up and down, there being no need to scroll left and right.

With reference again to FIG. 8, the document image 32 within the display area 60 is displayed on the display screen of the display unit 3 of the mobile telephone 1 (step 53). The display area 60 is moved, enlarged or reduced in accordance with the user operation applied to the mobile telephone 1 (step 54).

When an up- or down-scroll command is applied to the mobile telephone 1 (step 54), the display area 60 moves up or down in accordance with this scroll command (step 56).

With reference to FIG. 11, the display area 60 is moved downward if a down-scroll command is applied when the display area 60 is at the position at the top of the document image 32. The document image 32 after movement of the display area 60 is thus displayed (scrolled) on the display screen of the display unit 3.

If an enlargement command is applied to the mobile telephone 1 (step 54 in FIG. 8), the display area 60 is reduced in size (to a display area 61) (step 55 in FIG. 8), as illustrated in FIG. 11. Let w2 and h2 represent the width and height, respectively, of the display area 61.

The width of the document image 32 (the document image 30 may be utilized) is changed so as to take on a width identical with the width w2 of the reduced display area 61, and the character images 31 are re-arrayed, etc. (steps 51, 52 in FIG. 8).

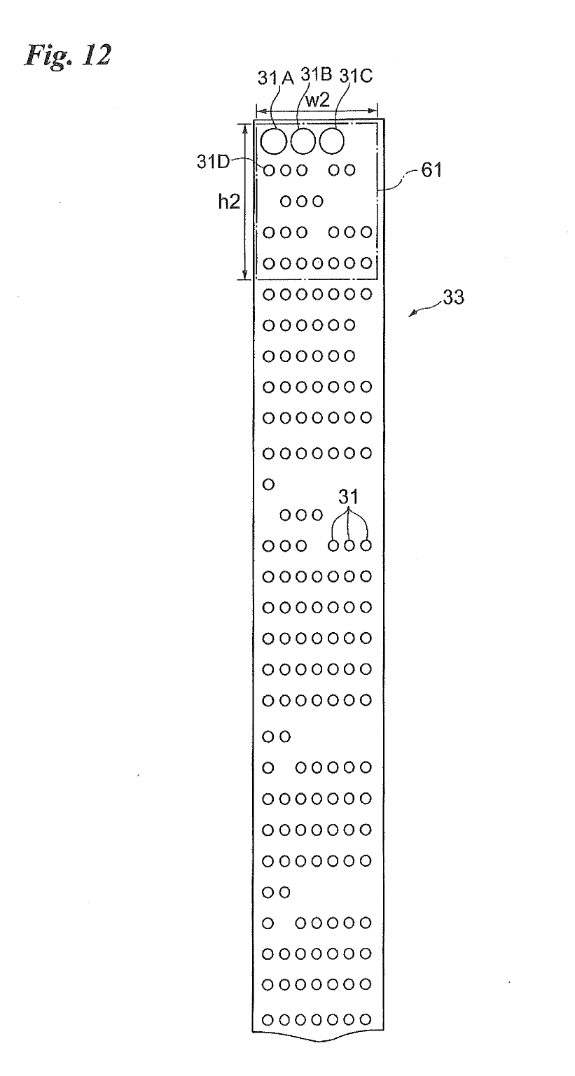

FIG. 12 is an example of a document image 33 the width of which has been made identical with the width w2 of the reduced display area 61. It will be understood that the document image 33 can be viewed, in a manner similar to that of the document image 32 shown in FIG. 11, merely by applying an up- or down-scroll command.

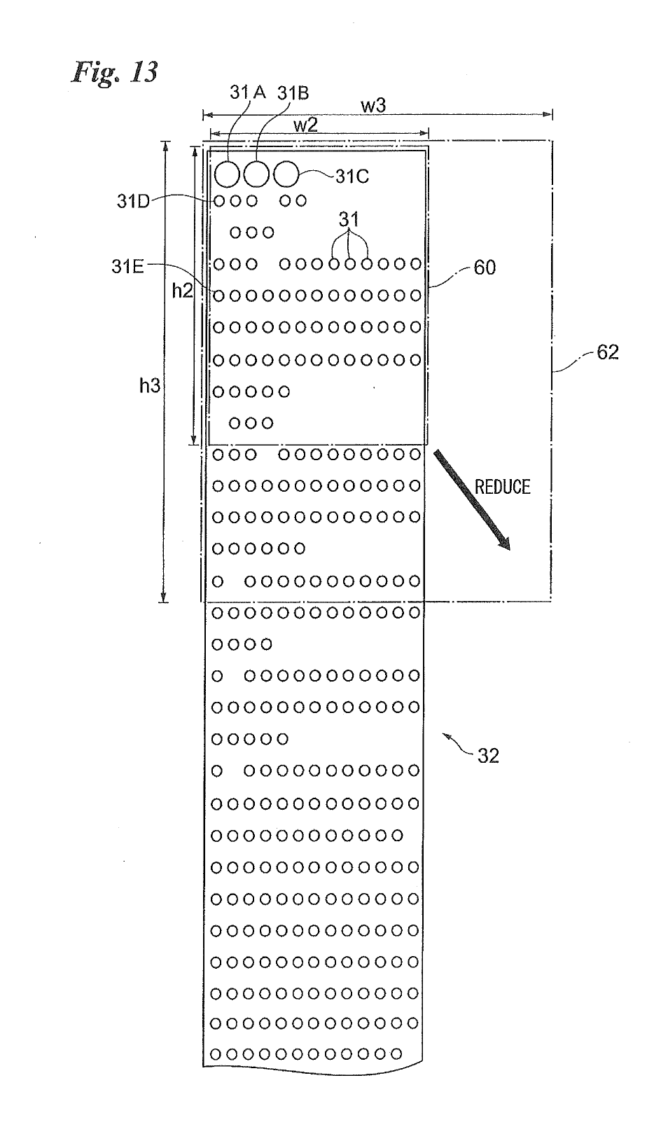

If a reduction command is applied to the mobile telephone 1 (step 54 in FIG. 8), the display area 60 is enlarged in size (to a display area 62) (step 55 in FIG. 8), as illustrated in FIG. 13. Let w3 and h3 represent the width and height, respectively, of the display area 62.

The width of the document image 32 (the document image 30 may be utilized) is changed so as to take on a width identical with the width w3 of the enlarged display area 62, and the character images 31 are re-arrayed, etc. (steps 51, 52 in FIG. 8).

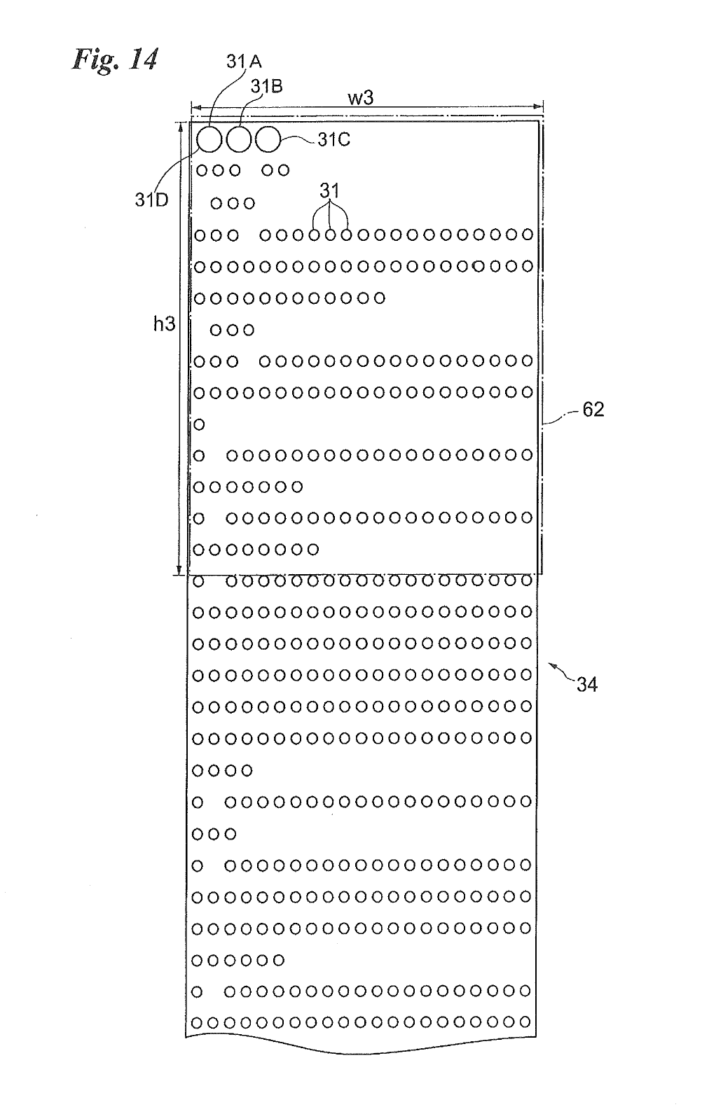

FIG. 14 is an example of a document image 34 the width of which has been made identical with the width w3 of the enlarged display area 62. It will be understood that the document image 34 can be viewed, in a manner similar to that of the document image 32 shown in FIGS. 11 and 12, merely by applying an up- or down-scroll command.

In the above-described embodiment, the flow of characters is that of horizontal writing, but operation is similar also in the case of a character flow that is vertical writing. In a case where the flow of characters is that of vertical writing, the size of the document image is changed so as to have a height the same as that of the display area (the array of the character images is changed as well). By moving the display area to the left or right in accordance with a left- or right-scroll command, the document image can be viewed by left and right scrolling alone. It goes without saying that even if the character flow is that of vertical writing, a document image enlarged or reduced in size in accordance with an enlargement reduction command will be displayed in a manner similar to that of horizontal writing.

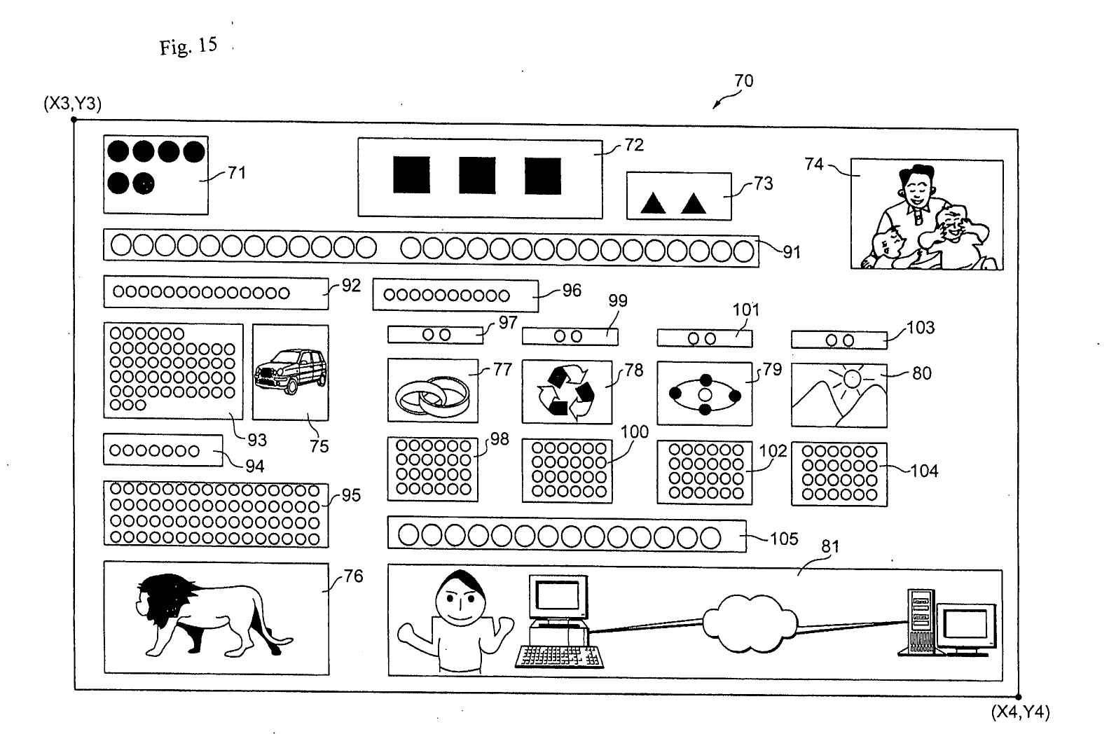

FIGS. 15 to 19 illustrate a modification.

FIG. 15 is an example of a document image 70.

Whereas the document image 30 shown in FIG. 4 is obtained by imaging a document composed solely of characters, the document image 70 illustrated in FIG. 15 is one obtained by imaging a document containing images (images represented by image files before the document is imaged) in addition to characters.

The document image 70 includes original image areas 71 to 81 and character image areas 91 to 105. The original image areas 71 to 81 are areas containing images represented by image files before the document image 70 is imaged. The character image areas 91 to 105 are areas containing text represented by text files before the document image 70 is imaged. However, since the document image 70 has been imaged, the character image areas 91 to 105 are image portions of parts of the document image 70. Characters represented by image files are expressed as black circles in the original image area 71, as black rectangles in the original image area 72, and by black triangles in the original image area 73. The characters in the character image areas 91 to 105 are represented by circles.

The document image 70 is horizontal writing, the upper-left vertex is represented by (X3,Y3) and the lower-right vertex is represented by (X4,Y4).

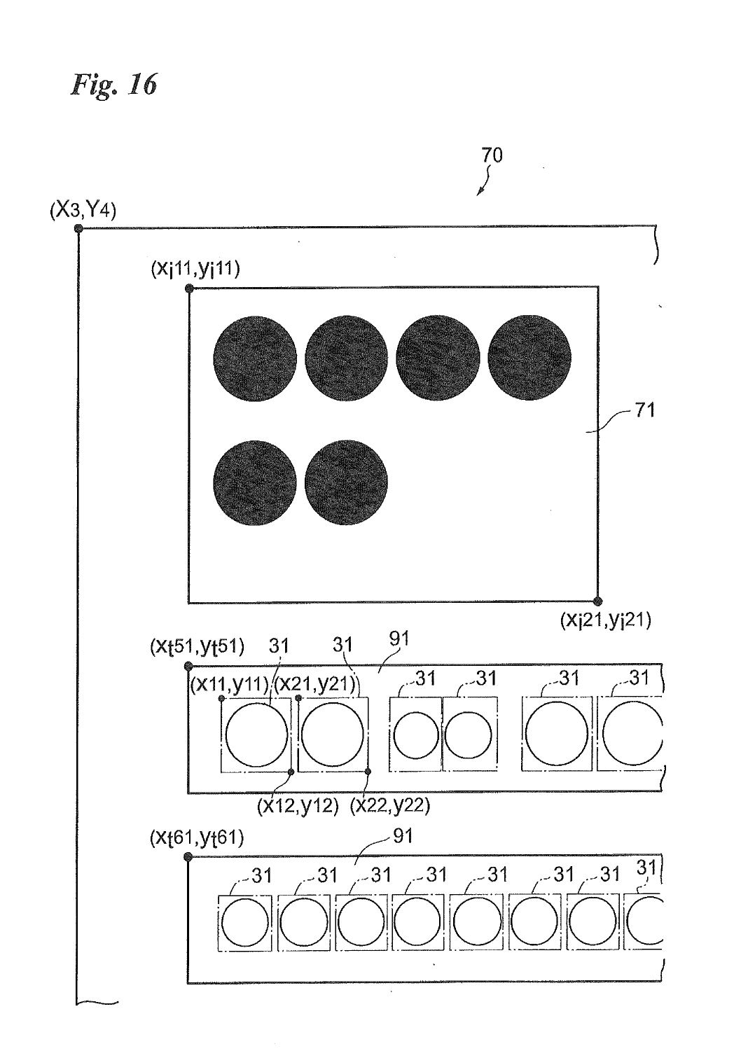

FIG. 16 illustrates the document image 70 enlarged in comparison with FIG. 15.

The document image 70 contains the original image areas 71 to 81 and the character image areas 91 to 105, as mentioned above. In order to specify the positions of the areas 71 to 81 and 91 to 105, the positional coordinates of the upper-left and upper-right vertices of each of the areas 71 to 81 and 91 to 105 are detected and stored in a list of positional coordinates. Furthermore, with regard to the character image areas 91 to 105, the positional coordinates of the upper-left and upper-right vertices of the squares enclosing the character images 31 contained in the character image areas 91 to 105 are also detected and stored in a list of positional coordinates.

For example, since the positional coordinates of the upper-left and lower-right vertices of the original image area 71 are (xi11,yi11) and (xi21,yi21), respectively, these coordinates xi11, yi11, xi21, yi21 are stored in the list of positional coordinates as the positional coordinates of the original image area 71. With regard to the character images 31 contained in the character image area 91, the coordinates of the upper-left and lower-right vertices of these character images 31 are stored in the list of positional coordinates, as mentioned above. With regard to the first character image 31 contained in the character image area 91, the positional coordinates of the upper-left vertex are (x11,y11) and the positional coordinates of the lower-right vertex are (y11,y12). Therefore, these coordinates x11, y11, x12, y12 are stored in the list of positional coordinates as the positional coordinates of the first character image 31 of the character image area 91.

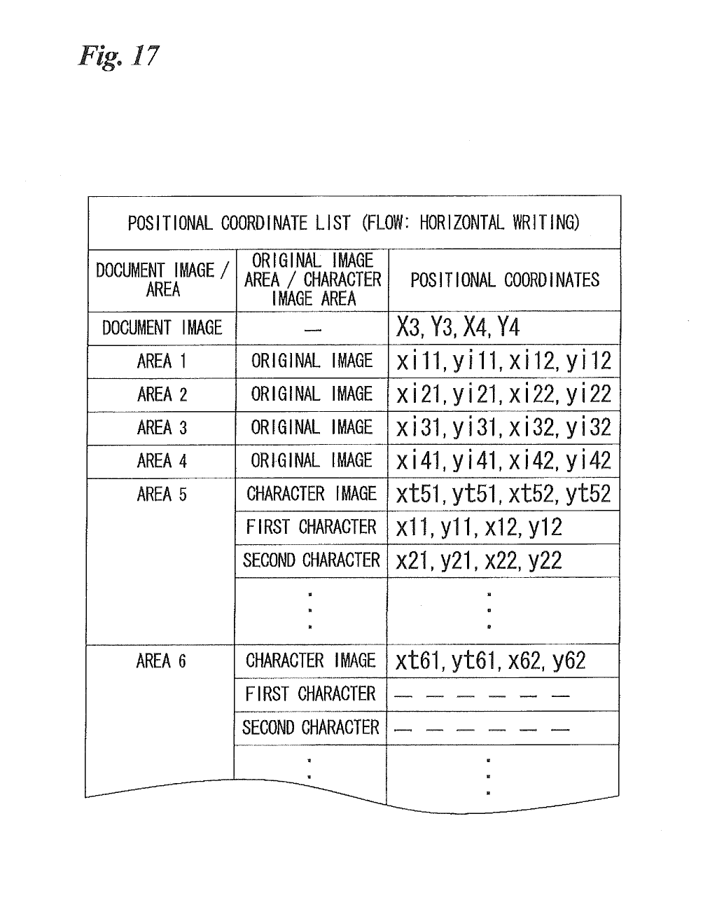

FIG. 17 is an example of the list of positional coordinates corresponding to the document image 70 shown in FIG. 15.

The list of positional coordinates contains the positional coordinates of the document image 70 and the positional coordinates of the areas (the original image areas 71 to 81 and the character image areas 91 to 105) contained in the document image 70. Numerical identification symbols have been appended with regard to the areas (original image areas 71 to 81, character image areas 91 to 105) contained in the document image 70. In the case of horizontal writing, as in document image 70, the identification symbols have been appended in numerical order from left to right and from top to bottom. The positions of the areas are decided in accordance with the identification symbols when the document image 70 is changed, as will be described later.

The list of positional coordinates also contains data indicating whether an area is one of the original image areas 71 to 81 or one of the character image areas 91 to 105. The positional coordinates of the character images 31 contained in respective ones of the character image areas 91 to 105 are also stored in the list of positional coordinates in association with the character image areas 91 to 105 that contain these character images 31.

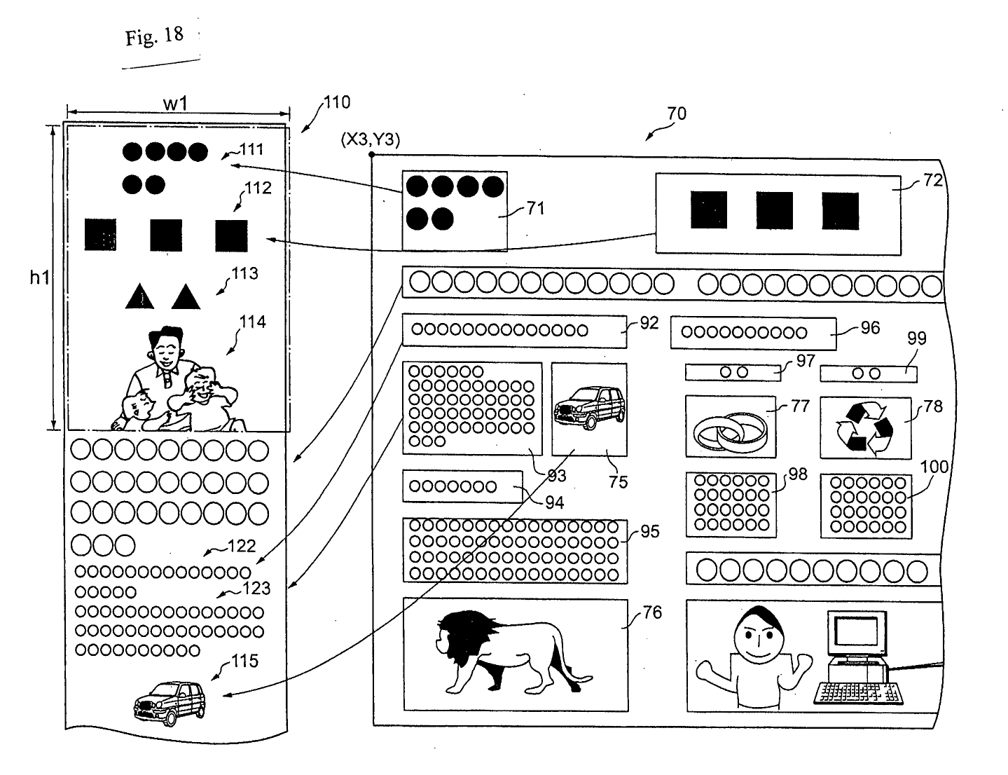

FIG. 18, which corresponds to FIG. 10, illustrates the manner in which the document image 70 is changed to a document image 110 having a width w1 identical with the width w1 of the display area 60 (step 52 in FIG. 8).

In a case where the document image 70 is changed to the document image 110 having a width the same as the width w1 of the display area 60, the original image areas 71 to 81 and the character image areas 91 to 105 are positioned from the top in the order of the identification symbols. With regard to the original image areas 71 to 81, centering processing is applied in such a manner that the center of one area will coincide with the center of the document image 110 in the transverse direction thereof. Enlargement or reduction may be performed, as a matter of course, in such a manner that both edges of one area along the transverse direction thereof will coincide with both sides of the document image 110 in the transverse direction thereof. With regard to the character image areas 91 to 105, the character images 31 contained in the character image areas 91 to 105 are extracted and the extracted character images 31 are re-arrayed in accordance with the character flow in a manner similar to that described above.

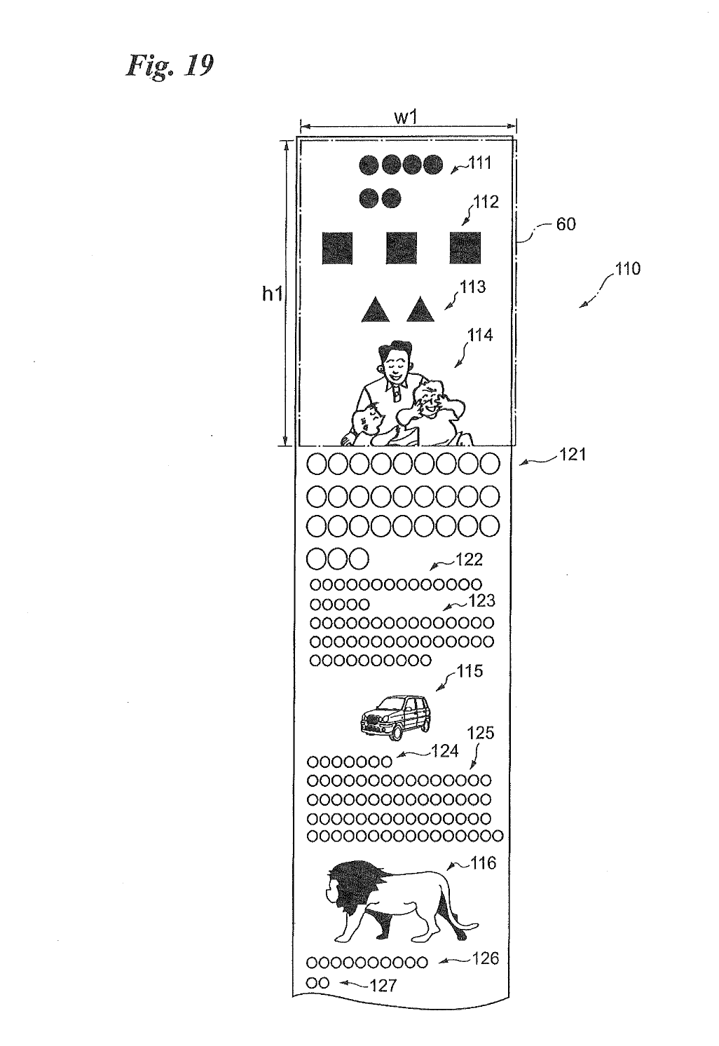

FIG. 19 is an example of the document image 110 generated so as to have a width identical with the width w1 of the display area 60.

Image portions 111, 112, 113, 114, 121, 122, 123, 115, 124, 125, 116, 126, 127 and 117 corresponding to the areas 71, 72, 73, 74, 91, 92, 93, 75, 94, 76, 96, 97 and 77, which are in numerical order corresponding to identification symbols, are represented in the document image 110.

Since the width w1 of the document image 110 is the same as the width of the display area 60, the document image 110 can be viewed by up and down scrolling alone. In a manner similar to that described above, the display area 60 is enlarged or reduced in size in accordance with an enlargement or reduction command, and the document image 70 (document image 110) is changed so as to take on a width the same as the width of the reduced or enlarged display area 60.

Although the above-described document image 110 is horizontal writing, it may just as well be vertical writing (it may be arranged so that whether the writing is horizontal or vertical can be designated). In the case of vertical writing, the identification symbols are decided in numerical order from top to bottom and from right to left. Further, in the case of vertical writing, the document image 110 is changed so that it will have a height the same as that of the display area 60.

In the foregoing embodiment, the mobile telephone 1 and document image server 20 are in communication, but it is not necessarily required that the mobile telephone 1 and document image server 20 communicate. For example, it may be arranged so that the imaging of a document image and the generation of a list of positional coordinates are carried out in the mobile telephone 1 rather than by the document image server 20, and it may be arranged so that a document image and list of positional coordinates that have already been generated are input to the mobile telephone 1. Further, it goes without saying that the invention is not limited to a mobile telephone but is also applicable to a reading device such as an electronic book. Furthermore, it may be arranged so that the document image server 20 executes the steps of 41 to 43 of FIG. 7, namely from the imaging of the document to the generation of the list of positional coordinates, as well as steps 51 and 52 of FIG. 8, namely the positioning of the display area and the changing of the document image. A document image can be viewed merely by scrolling along one axis even with a mobile telephone that utilizes a low-performance CPU.

1. A document image display device comprising:
a display area positioning device for positioning a display area, which defines a zone in which a display is presented on a display screen of a display unit, on a document image obtained by imaging a document;
a character image array device which, on the basis of positional coordinates of each character contained in the document image, is for arraying character images, which are a result of character-by-character extraction of character images representing the characters contained in the document image, within the display area in order in accordance with flow of the characters from a character being displayed uppermost in the display area in a case where flow of the document is that of horizontal writing, and within the display area in order in accordance with flow of the characters from a character being displayed rightmost in the display area in a case where flow of the document is that of vertical writing; and
a display unit for displaying the character images, which have been arrayed within the display area by said character image array device, on the display screen, wherein the document image contains, in addition to character image areas containing the character images, original image areas representing images which are represented by image files before the document is imaged,
an original image area adjusting device for executing centering processing so as to center the original image areas in the display area and for executing reduction processing such that the original image areas will be included in the display area or enlargement processing such that the original image areas will match the display area the character images being arrayed in the character image areas by said character image array device.

2. A document image display device according to claim 1, further comprising:
a command device for applying an enlargement command or a reduction command; and
a display area changing device for reducing the display area in size in accordance with an enlargement command from said command device and enlarging the display in size in accordance with a reduction command from said command device.

3. (canceled)

4. A document image display device according to claim 1, further comprising a layout changing device for rearranging placement of the original image areas and character image areas in accordance with flow of the characters; the document image having a width identical with width of the display area in regard to the document of horizontal writing and having a height identical with height of the display area in regard to the document of vertical writing.

5. A method of controlling operation of a document image display device, comprising:
a display area positioning device positioning a display area, which defines a zone in which a display is presented on a display screen of a display unit, on a document image obtained by imaging a document;
on the basis of positional coordinates of each character contained in the document image, a character image array device arraying character images, which are a result of character-by-character extraction of character images representing the characters contained in the document image, within the display area in order in accordance with flow of the characters from a character being displayed uppermost in the display area in a case where flow of the document is that of horizontal writing, and within the display area in order in accordance with flow of the characters from a character being displayed rightmost in the display area in a case where flow of the document is that of vertical writing; and
a display unit displaying the character images, which have been arrayed within the display area by the character image array device, on the display screen,
wherein the document image contains, in addition to character image areas containing the character images, original image areas representing images which are represented by image files before the document is imaged;
executing centering processing so as to center the original image areas in the display area and executing reduction processing such that the original image areas will be included in the display area or enlargement processing such that the original image areas will match the display area, the character images being arrayed in the character image areas by said character image array device.

6. A non-transitory recording medium storing a computer-readable program for controlling a computer of a document image display device so as to:
position a display area, which defines a zone in which a display is presented on a display screen of a display unit, on a document image obtained by imaging a document;
on the basis of positional coordinates of each character contained in the document image, array character images, which are a result of character-by-character extraction of character images representing the characters contained in the document image, within the display area in order in accordance with flow of the characters from a character being displayed uppermost in the display area in a case where flow of the document is that of horizontal writing, and within the display area in order in accordance with flow of the characters from a character being displayed rightmost in the display area in a case where flow of the document is that of vertical writing; and
displaying the character images, which have been arrayed within the display area, on the display screen
wherein the document image contains, in addition to character image areas containing the character images, original image areas representing images which are represented by image files before the document is imaged;
executing centering processing so as to center the original image areas in the display area and executing reduction processing such that the original image areas will be included in the display area or enlargement processing such that the original image areas will match the display area, the character images being arrayed in the character image areas by said character image array device.
